(19) United States
(12) Patent Application Publication
(10) Pub. No.: US 2010/0175104 A1
(43) Pub. Date: Jul. 8, 2010

(54) SAFE AND SECURE PROGRAM EXECUTION FRAMEWORK WITH GUEST APPLICATION SPACE

(76) Inventor: Atm Shafiqul Khalid, Redmond, WA (US)

Correspondence Address: ATM SHAFIQUL KHALID, 17446 NE 28TH ST., REDMOND, WA, 98052, US

(21) Appl. No.: 12/396,455

(22) Filed: Mar. 2, 2009

Related U.S. Application Data
(60) Provisional application No. 61/033,018, filed on Mar. 3, 2008.
(60) Provisional application No. 61/033,017, filed on Mar. 3, 2008.

(51) Int. Cl. G06F 21/22; G06F 3/048; G06F 9/54

(52) U.S. Cl. 726/1; 726/24; 715/847; 719/328

(57) ABSTRACT

A system and method is provided here that allow computer user to create a temporary guest running space for application without switching user environment. This unique method allows user to run trusted applications in regular running space while keeping a separate working space for applications that uses or visit non trusted data sources.

Proposed method provides a safe execution environment while application running in guest space can't temper or alter data information stored in regular running space. A set of policy rules dictates how information will be exchanged between applications running in two separate working spaces transparently.

The proposed system also make sure program files can't be altered or modified without proper need and suspicious call to modify program files or alter execution environment is blocked.

### CROSS REFERENCE OF RELATED APPLICATION

This application claims priority from U.S. provisional patent application Ser. No. 61/033,018 titled “SAFE AND SECURE PROGRAM EXECUTION FRAMEWORK WITH GUEST APPLICATION SPACE” filed on the 3 of Mar., 2008, the disclosure of which is incorporated by reference herein. This application claims priority from U.S. provisional patent application Ser. No. 61/033,017 titled “SAFE AND SECURE PROGRAM EXECUTION FRAMEWORK WITH DATA AND PROGRAM FILES PROTECTION” filed on the 3 of Mar., 2008, the disclosure of which is incorporated by reference herein.

### TECHNICAL FIELD

The present invention relates to application or system security by providing a means to run application in multiple working spaces so that the application can't temper or steal information providing better security. This also allows sharing information between applications running in separate space.

### BACKGROUND OF THE INVENTION

In modern computing environment security is one of the most important factors. It should be highest priority to make sure that a computer always executes safe computer instructions to maintain privacy and security. A computer will be connected to the network, and there will be outside attacker who will try to destabilize computing environment or steal valuable information stored somewhere in the network. The most common way to achieve those things is to find some exploitable hole and then inject some computer instruction that can be executed internally.

Theoretically, there will be always security vulnerability, and there will be a possibility that someone will be trying to push some bad stuff exploiting that vulnerability. Then it's up to the user/computer to deal with those bad stuffs. Most of the users are not expert and for example they can easily double click on an email attachment to welcome those bad stuffs. Or sometimes OS or some running program automatically welcome those bad stuff because of exploitable security hole in those application or OS.

Antivirus program is kind of passive protection. It can scan files for possible infection; it can scan memory for the similar thing. Those scanning process is assisted by some preset signatures to flag that memory or files are infected. However, there is no easy way to make conventional anti-virus application smart enough so that it can determine any newly written future virus. Firewall application typically blocks request from unknown or suspicious sources. However they can't block legitimate request. For example user need to browse internet, send email, use other network resources communicate other computers in the network. Sometimes some unintentional or ignorant act might cause problems. An email attachment might contain bad instructions. Or an employee might download a file from the internet and execute them locally that can eventually install bad stuff on computer. Therefore, those virus or firewall based protection are not good enough to identify new innovative future attack.

In this invention, we present a novel approach that combines existing Operating system features to create a separate application running space for applications based on its running mode. Such running mode might be as simple as guest running mode or regular running mode. When user browsing internet with unknown web site he might be victim or unwanted code intrusion. User might select to run those applications in guest mode. Operating system offers different user account with fast switching between user account where user can run applications with guest user account and switch back and forth.

However this approach has few usability flaws. User need to switch complete desktop environment meaning their regular running application will not be accessible with a click of mouse. Another disadvantage is guest user account in general doesn't share anything from the native user which might be problematic to user for example user might have a favorite list which can't be accessed in the same way from guest account. Proposed solution will enable sharing information when application runs in separate mode. There are some solution that can run program in isolation mode that require special installation and can't share information setting with non isolated space.

We also present a novel approach that can protect data or program files modification without affecting system performance or program functionality.

### SUMMARY OF THE INVENTION

The following presents a simplified summary of the present invention in order to provide some basic details of some aspects of the invention. This summary is not an extensive overview of the invention. It is not intended to identify key/critical elements of the invention or to reduce the scope of the invention. Its sole purpose is to present some concept of the invention in a simplified form; more detailed description is presented later.

In this document data or program files will refer to any persistent content typically stored in a file system that can be accessed by a program or user. The term can also refer to non persistent content is created on the fly, however the content can be accessed just like a regular persistent content. Memory mapped file or temporary files can be such non persistent content. More specifically data file will refer to non executable information like database, configuration storage like registry on windows etc. Program files will refer to any files that contain instruction that can be executed on a computing system. They can be in binary form like files with .exe .dll .sys .ocx extension on windows system. Program files can include script files that can be used to control program as well. Program files can contain information that can be recompiled or interpreted o the fly to control flow of a program. In this document program files will be used in generalized term that can include binary, data and any files a program might access directly or indirectly.

Regular application running mode is the usual scenario, user log into the system and launch an application and the application runs as if no component of this invention dictates the execution of the application. For reference we can call this regular running mode as primary working space which can be Windows Desktop once user log in. The primary working has its own desktop folder, document folder, registry hive etc.

Guest mode or protected mode is defined as when the regular application is launch in a different way where call from the application is manipulated in different way, the application might use different user account and share some information available to regular mode application. Guest application is just regular application or copy of regular application that is run in guest mode or protected mode environment. Therefore guest mode can be persistent or runtime behavior defined by a set of rules. Guest mode provides additional working space to user that can be transparent. Guest mode runs in guest work space that has its own desktop folder, own set of registry hive, own document folder etc. Guest space can work as a separate user in the system or use the current user context but all data and settings are stored at a separate location. Therefore it effectively create a virtual user context within the user space that is visible only to user.

In this document data or program files will refer to any persistent content typically stored in a file system that can be accessed by a program or user. The term can also refer to non persistent content is created on the fly, however the content can be accessed just like a regular persistent content. Memory mapped file or temporary files can be such non persistent content. More specifically data file will refer to non executable information like database, configuration storage like registry on windows etc. Program files will refer to any files that contain instruction that can be executed on a computing system. They can be in binary form like files with .exe .dll .sys .ocx extension on windows system. Program files can include script files that can be used to control program as well. Program files can contain information that can be recompiled or interpreted o the fly to control flow of a program. In this document program files will be used in generalized term that can include binary, data and any files a program might access directly or indirectly.

The present invention also provides a mechanism to lock the current system so that program or data file changes doesn't happen without scrutiny. This also intercepts and manipulates System Application Programming Interface (API) that is used to write or alter program or data files. Such method also intercepts and manipulates any data, configurations or memory content. Before committing such changes the method make sure such operation is safe to do.

### BRIEF DESCRIPTION OF THE DRAWINGS

FIG. 1 Block diagram for Guest Application Space

### DETAIL DESCRIPTION OF THE INVENTION

Corporate user often uses their corporate account to logon to their system. Those accounts have great privileges to access valuable corporate resources. When such user launch an internet browser the browser itself uses the credential of the users thus the browser can access corporate resources. When the user is visiting different internet sites or doing some research over the internet it not mandatory to run the browser with the full user account to run such application. In fact it would be much safer to use a least privilege user account. However, when using a separate user account to launch browser some information that could have been read only like browser history, favorite like, etc becomes inaccessible as well. Those disadvantages limit users to adopt such model. It would have been much nicer if the migration would have been transparent to user when user feels that they are using the same account and the resources the browser can access is manipulated on the fly and limited access is guaranteed.

It is possible to implement the subject matter in this invention without using a separate user account.

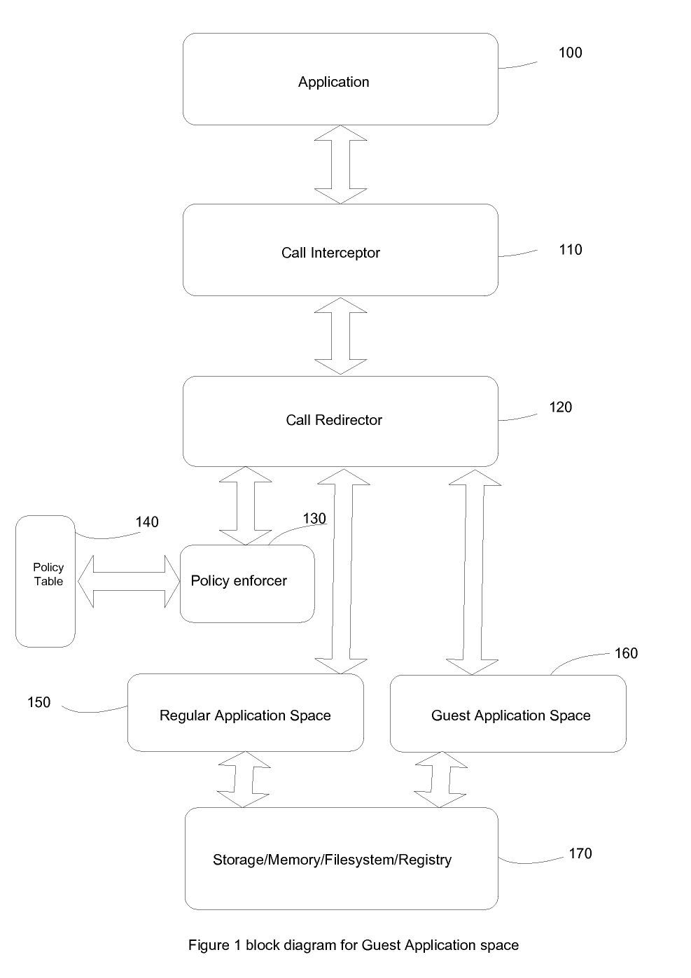

FIG. 1 shows various components of proposed system though various combinations of totally different pieces can be used to achieve to same utility implementing similar logic described in this invention.

Block 100 is a typically set of application user might run on their computing system. Computing system can be regular PC laptop of mobile phone etc. Application can be Microsoft word, Email application of some system application like disk manager or unwanted virus, spyware or malware software. Those applications can be in the form for .exe ocx, .sys, script or any other form understood by CPU or some interpreter that can execute. Application can be launched by user by clicking on icon, or some application might run on a preset schedule or triggered by some events in the system. Different component of application is typically stored in File system or database on some persistent storage like disk or flush memory (block 150). Application configuration is stored in system registry.

Block 110 is call interceptor that intercept calls coming from applications. To work properly application need to make various API call. For example the application needs to read configuration information in the registry on Windows system. In such case the call would RegOpenKey/RegCreateKey API to access a particular key. Similarly the application might call ReadFile/OpenFile/CreateFile to deal with file on file system. Call interceptor will intercept such call from application before it goes to the next layer. Interception can be done by overwriting API entry point or using various mechanism like jump table, modifying service entry table, overwriting function address, overwriting import table etc. Which method will be used will depend on particular environment and use case. Also Interception can happen at various levels as call follow through. For example app call OpenFile, then it might go to another layer like NtOpenFile then in goes to ZwOpenFile in the kernel then it goes to FsOpenFile interface in the driver. The call can be intercepted at any level.

Block 120 is call redirector that decides which space should receive the call to achieve the goal or comply with the policy. For example an application say browser wants to download a file while visiting an internet site. The downloaded file might be an image. The policy says that during this time all file copy should be directed to guest application space. When browser try to create the file on disk it will check parameter and determine it is trying to create file with in regular application space. In this case the call will be patched and redirected to guest application space. Similarly application might try to update configuration information like browsing history cookies, favorite list etc for browser application. The call redirector would redirect those calls to guest application space so that so changes happen in regular space. For example application accesses a registry key HKCU\Software\Microsoft\CurrentVersion\Windows\Internetexplorer\HistoryList using RegOpenKey call and the use RegSetValueEx to update history list. Call interceptor will intercept the request and call redirector will consult with policy enforcer to determine that the call should be redirected to Guest space. In such case the call will be modified with a new key location HKCU\RedirectedSoftware\Microsoft\CurrentVersion\Windows\Internetexplorer\History List. Similar way file update or other API can be redirected to new location keeping the regular location unchanged and at the same time allow the application to run in guest mode.

Block 130 is a policy enforcer that works with call redirector to ensure system policy is enforced that might redirect calls to regular application space or guest application space. It will have a policy table (block 140) that contains rules that describe how calls should be handled in block 120. Here are few example policies:
1. All call from an Application should be redirected to Guest application space.
2. Only update call should be redirected to Guest application space, and read call should be redirected to regular application space.
3. Define Copy_On_Write rule when update should copy the content form regular space into guest space and then modify.
4. A set of rules to define the root location of guest space.
5. A set of rules to define if application should run using the user credential and create a guest space within the user space or create a guest or different user credentials.
6. Policy enforcer can define a set of rules and means to copy information back and forth between guest space and regular space.

Block 150 is the placeholder to define regular running space for a user or a system. When a user log into the system a space is created on the system based on user properties and group. On Windows system, user has its own root location for user's files, root location for configuration information that differs from other users. Even though logical name or location might be the same physical location and content will differ. For example MyDocument logical name folder is same for user1 and user2 but their physical location is different. Regular application space will encapsulate the content or working area used by application in regular mode when no invention in this document is used. There might be some environment variable that defines user properties like profile location, user name etc. For a different user those locations might differ.

Block 160 is the placeholder for Guest application space. Guest application space is a separate working space that can reside within the user working space or use a completely separate user's space based on needs. A different root for space in the files system can be used that can reside inside users working space in file. For example “c:\Documents and Settings\User1” can be the root working space for regular application. For the same application while running in guest mode for all file access into “c:\Documents and Settings\user1” will be redirected to a new space “c:\Documents and Settings\User1\RedirectedSpace” Same thing applies for Registry access. If \\Registry\user\user1 is the root for registry access when application access in regular mode, a different root say \\Registry\user\user1\redirectedspace will be used when the application run in guest mode. It is possible to use a special user say GuestUser account for GuestSpace for all user in the system. Or another users guest spaces can be used for a different user. Guest space can be created during setup of the system or user account or on demand. Guest space can be deleted and recreated as needed without affecting regular application space. It is also possible to create a logical guest space where regular mode is considered trusted space where only trusted and known program module will be loaded. If a program loads unknown program modules or attempt to run unknown script or do some suspicious activities it can switch into guest mode.

An application can run in regular mode or in guest mode. Some parameters might dictate the mode. Guest launcher can be used to launch regular application in guest mode. Or some policy can define always run application in guest mode when a particular user is logged on or application or doing something different. For example launch browser in guest mode when user is browsing a site not within a know list. Regular mode to guest mode switch can happen during run time when application does some suspicious activities. Without blocking the application, running the application in guest mode will keep the application running. Sometimes blocking application simply results from many false positive; in such case keeping the application up at the same time protecting the system add good use case.

Block 170 is a placeholder for Files, or configuration information. This can also hold policy table. Hard disk flush memory or any kind of storage can be used.

Few supporting block can be added to enhance functionality.

For example a reporting block can be used to report any violation/activities in the system. Administrator can use those data for better manage their system.

A framework can be used to manage multiple systems that can enforce policy in the whole environment. In that case a central policy table can be used that would refresh policy on individual system.

Also and policy generator can be used that would create new policy based on the dynamics in the system and using some raw policy.

### Example Embodiment A

In this embodiment, a simple use case is developed where user can log on to the system with their regular credential however user get an option to run at least one application say browser to run in protected or guest space. Browser while running in guest space can access information while running in regular mode. However while running in guest or protected mode it create its own copy of those information when updates happens. This simulates Copy_On_Write behavior. Therefore guest browser will provide the same experience regular browser would do as long as guest mode browser doesn't issue any update. Once guest browser issue any update it creates its own copy without affecting regular mode browser. User can clean up all content of guest mode browser without affecting regular browser.

### Example Embodiment B

In addition to the embodiment of A, some strict rule is applied to the guest browser. Guest browser will not get any access to any content in certain area defined by a set of rules. The browser can run with the same user account as used to run browser in regular mode; however such restriction will add additional security. The way this will be implemented by intercepting API calls used to access files, registry configuration memory, network resources. Once those calls are intercepted, their target will be inspected and apply policy rules to check if such operation should be allowed. Interception can be done at various levels such as API in the user mode such as WriteFile, Service API such as NtWriteFile, hooking API in the kernel such as ZwWriteFile, or writing some filter drivers to intercept I/O. For Configuration like registry different set of API interception will be used.

### Example Embodiment C

In this embodiment a separate folder or container is created and any application running from that location will run in guest or protected mode. User can add a copy of regular program to run in guest mode. The way this will be implemented is when application runs, interceptor will check the location from where it was lunched, if it finds that it was lunched from a preset location meant to be launch pad for guest or protected mode application it would enable set of hooking and API manipulation to achieve full benefit of protected mode.

### Example Embodiment D

In this embodiment, a different user with less privilege is created to run guest mode application. During setup or initialization some foot print, history or configuration is copied over to the guest user environment. When regular users want to launch browser in guest mode, launcher simply run the application using the credential of the newly created users. In this case run time complexity of API manipulation will be avoided to some extent because application is running with less privilege. However additional restriction can be applied as well. This creates a unique way of solving a set of problems as bellow:
a. User need not to switch their regular environment and can run an application with different credential.
b. If application launched in such way modifies something this only affects guest user environment. For example the app can change users start up program list which will not affect the user start up program list.
c. Any update in guest environment can be recycled periodically keeping the regular environment safe.
d. Guest environment can copy information from regular environment as needed and allowed by policy.

### Example Embodiment for Program Files Protection

In general, when an intruder gets control of a computer system, it needs to put some code on the system on its persistent storage (such as file system on disk) so that the control exists even after the system reboot. The popular method is to install some dll, exe, rootkit driver or even to change boot record on disk or alter existing program or data module. Those unwanted operations can change configuration data files such as registry on Microsoft windows operating system.

Anti-virus or other existing popular security software attempt to scan files to look for some known pattern of data, instruction sets or some signature to identify suspicious module. Those security software products fail if signature is not known or the suspicious program can manage itself by hiding into the system. Also some smart bad application can changes its signature on the fly and sometimes on every run that makes it much harder to detect.

The proposed solution focuses on protecting the existing program module and doesn't allow installing any new program module unnecessarily. At the same time it makes sure regular operation can occur in the system to make the system effective.

Let us take an specific example, a user visit a website that activate some control on the browser that eventually write a new unknown program malaware.exe on users system and change the system start-up program list to include maaware.exe program so that malaware.exe runs every time the user boot-up or log on to the system. Let's assume that the start-up program list is stored in registry on Windows system. There might be various form and ways of installing a malwares program on users system, for example the program might be a service, device driver, script files, dll, ActiveX control, Word macro, or combination of them or tempering existing files or modifying or manipulating configuration information. Configuration information might be a way to activate the code through service entry, runonce registry key, run key, logon scripts, file associations etc. It's very difficult to describe all those different variations however a single example can demonstrate how those malicious or unwanted operation can be protected.

When browser attempt to write those module on persistent storage like file system it need to call some Application programming interface (API) like OpenFile/WriteFile or some low-level interfaces like DeviceIoControl. The proposed method will intercept those API call from browser before those call can alter anything in the system. An API interceptor or filter driver will be used to achieve such interception. Once call is intercepted it will look at the parameters to decide if the resultant operation is affecting a program module file or going to create a new program module. When operating system load a program it validate the program module 1^{st} to make sure the module format is correct. The interceptor will use the similar validation technique to decide if the resultant call will alter/create a new program files. Such Signature validation technique will extract some piece of information like, image signature, Image machine type, header format, section formats, initial program instructions checksums etc. If the data passed in the call is not sufficient, interceptor will read mode data from the original file to get sufficient data before it can apply its validation logic.

To apply such validation logic on every single API call might slow down the performance of the system. In that case some caching will be used. Also when application open the file before writing it typically pass some access mode flag like Read_Only, or Read_Write etc. Typically many write calls happens once a file is created or opened for writing. So it would be easier to manipulate the open call and take some system built-in interface/feature to manipulate write call without affecting performance. The proposed method will manipulate open call and modify the required access to Read_Only if it detects that the target file is a binary module and return a reference handle to the file that has only read access. When Application uses the handle to write into the file the call fails. Many applications use all_access on file during open call even though those applications only read file. Blocking such call at the beginning would fail such applications immediately. Proposed method will succeed the open call with read_only access if the call was meant for tempering program files and system policy is set to protect the system by filtering all_access and automatically blocks write calls if any happens later on.

### Typical Application:

hFile = OpenFile (c:\programfiles\Mycompany\myprogrm.exe)
while ( GetData(DataBuff, Datasize))

WriteFile (hFile, DataBuff, Length)

Now the proposed method also includes a policy component that can set some rules when exception needs to occur to allow user to install new program on their system or update their system. There will be a simple rule LockSystem with TRUE or FALSE attribute. When the rule is set to TRUE binary protection will be applied. When the policy is set to false protection will not be applied. When user install a new program or update its system user can unlock the system and lock it back when done. User will set another rule to schedule an Unlock for a specified window of time to allow some automatic update/installation within a given window. For example user can schedule an unlock operation when Windows update kicks in. User can set another rule that can unlock the system based on some system events like when a new patch is available, or some specific program is attempting to open a port or trying to write something on some specified location.

User can set a rule to allow program file modification targeted to a specified location. For example user might use some guest account to run some applications. Application might be allowed to do any updates on the directory having guest user files. However it wouldn't allow any update outside the location. When user is done, user can delete those guest user contents without affecting user's content.

What is claimed is:

1. A system and method protect computing system comprising:
a) a management component to create at least one new working space and manage it,
b) an API call intercept processor to inspect intercept or manipulate system calls,
c) a policy module containing rules that defines how the said system calls is redirected or manipulated,
d) a method that collects intercepted parameters from intercepted API, apply rules from policy module and redirect those calls,
whereby, program if infected will modify data on a secondary working space keeping primary working space intact and eventually protecting the system and user privacy is protected because secondary working space can be recreated or disposed easily.

2. Working space as recited in claim 1 further comprises
a) a mean to allocate and manage file storage,
b) a mean to allocate and manage user configuration data,
c) a mean to create and manage user profile data where working space work as a virtual user space,
d) a mean to share user data among various working spaces.

3. A management component as recited in claim 1 further comprising:
a. a method to create new working spaces consisting of subset of information needed for primary working space such as regular desktop environment for windows desktop,
b. a method to initialize the new working space,
c. a set of attributes that makes the new space hidden or exposable to user configurable through policy module.

4. A management component as recited in claim 1 further comprising:
a) a means to switch among working spaces,
b) a means to run program in an alternate working space and access the program without switching the space,
c) a mean to mark application to run in a specific working space,
whereby, user can click on a shortcut icon on his users desktop to launch browser in primary space and click on another shortcut icon on user's desktop to launch browser on alternate working space where those two browsers doesn't share cookies, favorite lists, browsing history and if one browser is infected doesn't affect the other even after reboot.

5. A management component as recited in claim 1 comprises a mean to create icons on desktop or computer screen where each icon represents shortcut to program(s), program group(s) or working spaces, thus user can simply click on icon and easily lunch program at different working spaces.

6. A management component as recited in claim 1 implement copy_on_write method comprising:
a) a mean to set an working space as read only working space,
b) a mean to create new working space initializing it with the same information of read only working space without copying it,
c) a method to copy necessary information when program running in the new working space modify data so that readonly working space and new working space exist side by side,
whereby, user can click on a shortcut icon on his users desktop to launch browser in primary space and click on another shortcut icon on user's desktop to launch browser on a copy_on_write working space where those two browsers share cookies, favorite lists, browsing history at the current point of time and any subsequent changes stay separate.

7. Working space as recited in claim 1 comprises a primary space that constitute user's regular running space such as desktop on windows OS and additional space(s) that exists within the users space in such a way as if a new user space called virtual user space created in the system but only the user can see the virtual user space.

8. Working space as recited in claim 1 include a method to keep its own part of user configuration data, or application data within a particular user space where it can inherit user security settings.

9. Working space as recited in claim 1 comprises a method to share its configuration or application data among all its own working space that allows user to run an application in multiple spaces with common settings.

10. Working space as recited in claim 1 comprises a method to keep common settings for multiple users that allows multiple users to run programs at user's working space(s) with common settings.

11. An API call intercept processor as recited in claim 1 is embedded in the module of respective API where code of those API is modified and recompiled, whereby, allowing implementing the interception without doing any runtime API interception.

12. An API call intercept processor as recited in claim 1 inject a DLL that manipulate the function entry points function table such as import table, or overwrite existing function code, or use system provided mechanism to implement interception.

13. An API call intercept processor as recited in claim 1 comprises a step to collect API call parameters; retrieve rules from policy module that is applicable for this particular call, and then determines which working space(s) it should target, and modify the call parameters with different set parameters or replace the call with a different set of calls.

14. A policy module as recited in claim 1 contains policy how interception should be done for a given system, or how working space(s) should be managed or created, or how API call should be manipulated.

15. A policy module as recited in claim 1 is implemented in other components of the system and method as recited in claim 1 in a hard coded way to bypass a separate policy module, whereby, allowing an implementation of a preset policy preconfigured for a particular set of user(s) or systems.

16. A policy module as recited in claim 1 creates it rule based on predefined information in a database, or creates information collecting application profiling data that covers how different application is executed, what kind of data application access, how applications are installed or deployed across different computer systems in the network.

17. A system and method to protect program modules and working space comprising:
a) an API call intercept processor to inspect intercept or manipulate system calls,
b) a policy module containing rules that defines how the calls should be redirected or manipulated,
c) a step that would identify if an API call or set of API calls about to create or modify a program modules or execution environment settings for a working space and allow disallow or modify the call using rules in said policy module,
whereby, users can keep its primary working space with all program module in read only state and block any calls that can modify those program modules such as exe file driver files and make the work space program module writeable while doing maintenance work such as program installation or updating the system.

18. A policy module as recited in claim 17 further comprise a mean to collect information by inspecting different computer systems in the network, look at the program modules installed in those systems and collect data how those program modules are installed and changed over time.

19. A policy module as recited in claim 17 further comprises
a) a mechanism to interact with the user so that user can set/modify policy to lock their system and unlock it later,
b) a rule how some section of data in a program files is used to define if the file is program files or data file,
c) a rule that defines is changes is going to affect working space run time environment persistently that launches new program.

20. A system and method for a protection framework comprising:
a) an API call intercept processor to inspect intercept or manipulate system calls,
b) a policy module containing rules that defines how the calls should be redirected or manipulated or new rules should be created,
c) a step that to identify if an API call or set of API calls is about to create or modify a program modules or change execution environment settings and allow disallow or modify the call,
d) a management component to manage multiple working space,
e) a framework where interconnected computers communicate with each other to collect data to create new rules that allow to create a protective environment,
whereby, enabling users to protect its program modules or working space by connecting different computers and build protection shield sharing information among different computers by deploying disposable working space, using read only working spaces, copy_on_write working space or blocking calls that can modify program modules that greatly enhance users privacy and security.
